(19) United States
(12) Patent Application Publication
(10) Pub. No.: US 2024/0373373 A1
(43) Pub. Date: Nov. 7, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/774,930

(22) Filed: Jul. 17, 2024

Related U.S. Application Data
(63) Continuation of application No. PCT/CN2023/072514, filed on Jan. 17, 2023.

(30) Foreign Application Priority Data
Jan. 21, 2022 (CN) 202210071479.2

(51) Int. Cl. H04W 52/42; H04W 52/14; H04W 52/36

(52) U.S. Cl. CPC H04W 52/42; H04W 52/146; H04W 52/365

(57) ABSTRACT

The node firstly receives a first information set, the first information set indicating a first reference signal resource set; and then transmits a second information set; the second information set includes a first power difference and a second power difference; the first power difference is equal to a difference obtained by subtracting a first target power value from a first power value, and the second power difference is equal to a difference obtained by subtracting a second target power value from a second power value; the first target power value and the second target power value are both associated to a first reference signal resource in the first reference signal resource set; the first target power value and the second target power value are for a same cell. This application improves uplink power control under multi-panel terminals to increase system flexibility.

### CROSS REFERENCE TO RELATED APPLICATIONS

This application is the continuation of the international patent application No. PCT/CN2023/072514, filed on Jan. 17,2023, and claims the priority benefit of Chinese Patent Application No. 202210071479.2, filed on Jan. 21,2022, the full disclosure of which is incorporated herein by reference.

### BACKGROUND

### Technical Field

The present application relates to transmission methods and devices in wireless communication systems, and in particular to a transmission scheme and device for uplink power control reporting in wireless communications.

### Related Art

The 5G wireless cellular communication network system (5G-RAN) enhances the uplink power control of UE based on the already-existing Long-Term Evolution (LTE). Compared to LTE, due to the absence of Common Reference Signal (CRS) in the NR system, the measurement of pathloss required for uplink power control shall be performed using Channel State Information Reference Signal (CSI-RS) and SS/PBCH Block (SSB). In addition, the most important feature of the NR system is the introduction of the beam management mechanism. The terminal can communicate with multiple different transmitting and receiving beams, and thus the terminal needs to be able to measure multiple pathlosses corresponding to multiple beams, in which one way of determining the pathloss is to indicate to a certain associated downlink RS resource by means of a Sounding Reference Signal Resource Indicator (SRI) in the DCI.

In the discussion of NR R17, the scenario where multiple Panels are configured on the terminal side has been adopted, and the impact on power control brought about by the introduction of multiple Panels needs to be considered accordingly.

### SUMMARY

In the discussion of NR R17, enhancements are made to the terminal's transmissions, and one important aspect is the introduction of two Panels, which can be employed by the terminal to transmit on two transmitting beams at the same time in order to obtain better spatial diversity gain. However, an important indicator for uplink transmission is power control. Whether the same power control parameter is applied for two Panels when adopted simultaneously and one panel when adopted solely, and whether there is dynamic allocation of power between the two Panels will have an impact on the practice of uplink power control under multi-Panel circumstance, and furthermore, the existing reporting mechanism of PHR (i.e., Power Headroom Report) also needs to be reconsidered.

The present application discloses a solution to the above problem of uplink power control in multi-panel scenarios. It should be noted that in the description of the present application, multiple panels are only used as an exemplary application scenario or example: the present application is equally applicable to other scenarios facing similar problems, such as single-panel scenarios, or for different technical fields, such as technical fields other than uplink power control, or the field of measurement reporting, or other non-uplink power control fields such as uplink data transmission, to achieve similar technical results. Additionally, the adoption of a unified solution for various scenarios, including but not limited to multi-panel scenario, contributes to the reduction of hardcore complexity and costs. In the case of no conflict, the embodiments of a first node and the characteristics in the embodiments may be applied to a second node, and vice versa. Particularly, for interpretations of the terminology; nouns, functions and variables (unless otherwise specified) in the present application, refer to definitions given in TS36 series, TS38 series and TS37 series of 3GPP specifications.

The present application provides a method in a first node for wireless communications, comprising:
receiving a first information set, the first information set being used to indicate a first reference signal resource set; and
transmitting a second information set;
herein, the second information set includes a first power difference and a second power difference: the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a Physical Uplink Shared Channel (PUSCH).

In one embodiment, the above method is characterized in that for one SRS (i.e., Sounding Reference Signal) resource in an SRS resource set, the first node reports two PHRs to provide more reference to inform the base station of the respective remaining power values corresponding to the base station in cases of adopting single-Panel transmission and multi-Panel transmission.

In one embodiment, the above method is characterized also in that for a same uplink beam, the upper limit of a corresponding transmission power value is different for single-panel transmission and multi-panel transmission, and thus multiple PHRs for an uplink beam need to be reported at the same time.

According to one aspect of the present application, the first information set is used to indicate a second reference signal resource set: the second information set includes a third power difference and a fourth power difference: the third power difference is equal to a difference obtained by subtracting a third target power value from a third power value, and the fourth power difference is equal to a difference obtained by subtracting a fourth target power value from a fourth power value: the third target power value and the fourth target power value are both associated to a second reference signal resource in the second reference signal resource set: the third target power value and the fourth target power value are for a same cell, and both the third target power value and the fourth target power value are for a PUSCH.

In one embodiment, the above method is characterized in that when the first node is configured with two SRS resource sets, with respect to one SRS resource in the other SRS resource set, the first node will report two PHRs as well to provide more reference to inform the base station of the respective remaining power values corresponding to the base station in cases of adopting single-Panel transmission and multi-Panel transmission.

According to one aspect of the present application, the first power value and the second power value are both associated to the first reference signal resource set, while the third power value and the fourth power value are both associated to the second reference signal resource set: the first power value is different from the second power value, and the third power value is different from the fourth power value.

In one embodiment, the above method is characterized in that the first power value is a power control parameter adopted for a first one of two SRS reference resource sets when being used individually, and the second power value is a power control parameter adopted for the first one of the two SRS reference resource sets when the two SRS reference resource sets are used simultaneously.

In one embodiment, the above method is characterized in that the third power value is a power control parameter adopted for a second one of two SRS reference resource sets when being used individually, and the fourth power value is a power control parameter adopted for the second one of the two SRS reference resource sets when the two SRS reference resource sets are used simultaneously.

According to one aspect of the present application, comprising:
receiving a first signaling; and
transmitting a first signal;
herein, the first signaling is used to determine the first reference signal resource, and the first reference signal resource is used to determine a spatial transmission (Tx) parameter for the first signal, a transmission power value of the first signal being equal to the first target power value.

According to one aspect of the present application, comprising:
not having detected any downlink control information used to indicate uplink scheduling in a first time window;
herein, the uplink scheduling includes a physical uplink shared channel, and a power control parameter associated with the first reference signal resource is pre-defined.

According to one aspect of the present application, comprising:
receiving a first signaling; and
transmitting a first signal;
herein, the first signaling is used to determine the first reference signal resource and the second reference signal resource, and the first signal comprises a first sub-signal and a second sub-signal; the first reference signal resource is used to determine a spatial transmission (Tx) parameter for the first sub-signal, while the second reference signal resource is used to determine a spatial Tx parameter for the second sub-signal; a transmission power value of the first sub-signal is equal to the second target power value, and a transmission power value of the second sub-signal is equal to the fourth target power value.

According to one aspect of the present application, a power control parameter associated with the second reference signal resource is predefined.

According to one aspect of the present application, a first value and a second value are both associated to the first reference signal resource set, and a first coefficient and a second coefficient are both associated to the first reference signal resource set; the first value and the first coefficient are used to determine the first target power value, while the second value and the second coefficient are used to determine the second target power value; the first value and the second value are of a same type, and the first coefficient and the second coefficient are of a same type.

In one embodiment, the above method is characterized in that two sets of power control parameters are configured, which respectively include a first value and a first coefficient, and a second value and a second coefficient; both of the two parameter sets correspond to a same given beam; one set of parameters is adopted when the given beam is used for single-panel transmission, and the other set of parameters is adopted when the given beam is used for multi-panel simultaneous transmission.

The present application provides a method in a second node for wireless communications, comprising:
transmitting a first information set, the first information set being used to indicate a first reference signal resource set; and
receiving a second information set;
herein, the second information set includes a first power difference and a second power difference: the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a PUSCH.

According to one aspect of the present application, the first information set is used to indicate a second reference signal resource set: the second information set includes a third power difference and a fourth power difference: the third power difference is equal to a difference obtained by subtracting a third target power value from a third power value, and the fourth power difference is equal to a difference obtained by subtracting a fourth target power value from a fourth power value: the third target power value and the fourth target power value are both associated to a second reference signal resource in the second reference signal resource set: the third target power value and the fourth target power value are for a same cell, and both the third target power value and the fourth target power value are for a PUSCH.

According to one aspect of the present application, the first power value and the second power value are both associated to the first reference signal resource set, while the third power value and the fourth power value are both associated to the second reference signal resource set: the first power value is different from the second power value, and the third power value is different from the fourth power value.

According to one aspect of the present application, comprising:
transmitting a first signaling; and
receiving a first signal;
herein, the first signaling is used to determine the first reference signal resource, and the first reference signal resource is used to determine a spatial transmission (Tx) parameter for the first signal, a transmission power value of the first signal being equal to the first target power value.

According to one aspect of the present application, comprising:
not transmitting any downlink control information used to indicate uplink scheduling of a first node in a first time window;
herein, the uplink scheduling includes a physical uplink shared channel, and a power control parameter associated with the first reference signal resource is pre-defined; a transmitter of the second information set includes the first node.

According to one aspect of the present application, comprising:
transmitting a first signaling; and
receiving a first signal;
herein, the first signaling is used to determine the first reference signal resource and the second reference signal resource, and the first signal comprises a first sub-signal and a second sub-signal; the first reference signal resource is used to determine a spatial transmission (Tx) parameter for the first sub-signal, while the second reference signal resource is used to determine a spatial Tx parameter for the second sub-signal; a transmission power value of the first sub-signal is equal to the second target power value, and a transmission power value of the second sub-signal is equal to the fourth target power value.

According to one aspect of the present application, a power control parameter associated with the second reference signal resource is predefined.

According to one aspect of the present application, a first value and a second value are both associated to the first reference signal resource set, and a first coefficient and a second coefficient are both associated to the first reference signal resource set; the first value and the first coefficient are used to determine the first target power value, while the second value and the second coefficient are used to determine the second target power value: the first value and the second value are of a same type, and the first coefficient and the second coefficient are of a same type.

The present application provides a first node for wireless communications, comprising:
a first receiver, receiving a first information set, the first information set being used to indicate a first reference signal resource set; and
a first transmitter, transmitting a second information set;
herein, the second information set includes a first power difference and a second power difference; the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a PUSCH.

The present application provides a second node for wireless communications, comprising:
a second transmitter, transmitting a first information set, the first information set being used to indicate a first reference signal resource set; and
a second receiver, receiving a second information set;
herein, the second information set includes a first power difference and a second power difference: the first power difference is equal to a difference obtained by subtracting a first target power value from a first power value, and the second power difference is equal to a difference obtained by subtracting a second target power value from a second power value; the first target power value and the second target power value are both associated to a first reference signal resource in the first reference signal resource set: the first target power value and the second target power value are for a same cell, and both the first target power value and the second target power value are for a PUSCH.

In one embodiment, this application is advantageous in that it improves the completeness of PHR reporting under multi-panel, which in turn improves power control efficiency and transmission performance.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of a first information set according to one embodiment of the present application.

FIG. 6 illustrates a flowchart of a first signaling according to one embodiment of the present application.

FIG. 7 illustrates a flowchart of a first signaling according to another embodiment of the present application.

FIG. 8 illustrates a flowchart of downlink control information according to one embodiment of the present application.

FIG. 9 illustrates a schematic diagram of a second information set according to one embodiment of the present application.

FIG. 10 illustrates a schematic diagram of a first reference signal resource set and a second reference signal resource set according to one embodiment of the present application.

FIG. 11 illustrates a schematic diagram of a first node according to one embodiment of the present application.

FIG. 12 illustrates a schematic diagram of antenna ports and antenna port groups according to one embodiment of the present application.

FIG. 13 illustrates a structure block diagram of a processing device in a first node according to one embodiment of the present application.

FIG. 14 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

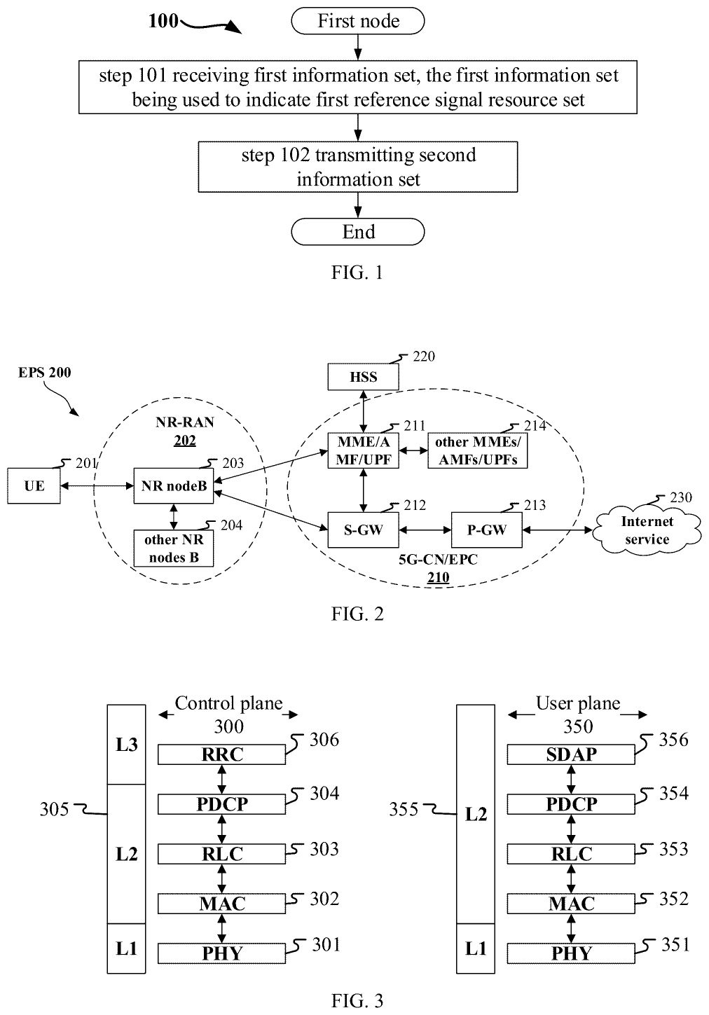

Embodiment 1 illustrates a flowchart of processing of a first node, as shown in FIG. 1. In 100 illustrated by FIG. 1, each box represents a step. In Embodiment 1, the first node in the present application receives a first information set in step 101, the first information set being used to indicate a first reference signal resource set; and transmits a second information set in step 102.

In Embodiment 1, the second information set includes a first power difference and a second power difference; the first power difference is equal to a difference obtained by subtracting a first target power value from a first power value, and the second power difference is equal to a difference obtained by subtracting a second target power value from a second power value; the first target power value and the second target power value are both associated to a first reference signal resource in the first reference signal resource set; the first target power value and the second target power value are for a same cell, and both the first target power value and the second target power value are for a PUSCH.

In one embodiment, the first information set is transmitted via a Radio Resource Control (RRC) signaling.

In one embodiment, the first information set is configured by RRC signaling.

In one embodiment, the RRC signaling that transmits or configures the first information set comprises one or more fields in a PUSCH-PowerControl in Specification.

In one embodiment, the RRC signaling that transmits or configures the first information set comprises a PUSCH-PowerControl in Specification.

In one embodiment, the RRC signaling that transmits or configures the first information set comprises a PUSCH-P0-PUSCH-AlphaSet in Specification.

In one embodiment, the RRC signaling that transmits or configures the first information set comprises one or more fields in an SRI-PUSCH-PowerControl in Specification.

In one embodiment, the RRC signaling that transmits or configures the first information set comprises an SRI-PUSCH-PowerControl in Specification.

In one embodiment, the RRC signaling that transmits or configures the first information set comprises one or more fields in a CSI-ResourceConfig in Specification.

In one embodiment, the RRC signaling that transmits or configures the first information set comprises one or more fields in a CSI-SSB-ResourceSet in Specification.

In one embodiment, the RRC signaling that transmits or configures the first information set comprises one or more fields in an SRS-Config in Specification.

In one embodiment, the name of the RRC signaling that transmits or configures the first information set includes Power.

In one embodiment, the name of the RRC signaling that transmits or configures the first information set includes Control.

In one embodiment, the name of the RRC signaling that transmits or configures the first information set includes PUSCH.

In one embodiment, the name of the RRC signaling that transmits or configures the first information set includes Channel State Information (CSI).

In one embodiment, the name of the RRC signaling that transmits or configures the first information set includes CSI-RS.

In one embodiment, the name of the RRC signaling that transmits or configures the first information set includes SRS.

In one embodiment, the name of the RRC signaling that transmits or configures the first information set includes SRI.

In one embodiment, the first reference signal resource set is identified by an SRS-ResourceSetId.

In one embodiment, the first reference signal resource set corresponds to an SRS Resource Set.

In one embodiment, the first reference signal resource set comprises one reference signal resource.

In one subembodiment, the reference signal resource included in the first reference signal resource set is an SRS Resource.

In one subembodiment, the reference signal resource included in the first reference signal resource set is a CSI-RS resource.

In one subembodiment, the reference signal resource included in the first reference signal resource set is an SSB.

In one embodiment, the first reference signal resource set comprises K1 reference signal resources, K1 being a positive integer greater than 1.

In one subembodiment, any one of the K1 reference signal resources included in the first reference signal resource set is an SRS Resource.

In one subembodiment, at least one of the K1 reference signal resources included in the first reference signal resource set is an SRS Resource.

In one subembodiment, any one of the K1 reference signal resources included in the first reference signal resource set is a CSI-RS resource.

In one subembodiment, any one of the K1 reference signal resources included in the first reference signal resource set is an SSB.

In one embodiment, a physical layer channel occupied by the second information set includes a PUSCH.

In one embodiment, a physical layer channel occupied by the second information set includes a Physical Uplink Control Channel (PUCCH).

In one embodiment, the second information set is a Medium Access Control (MAC) Control Element (CE).

In one embodiment, the second information set is a PHR.

In one embodiment, the first power difference is measured in dBm.

In one embodiment, the second power difference is measured in dBm.

In one embodiment, the first power difference is measured in dB.

In one embodiment, the second power difference is measured in dB.

In one embodiment, the first power difference is measured in mW.

In one embodiment, the second power difference is measured in mW.

In one embodiment, the first power value is P_{CMAX,f,c}(i) of Specification.

In one embodiment, the second power value is P_{CMAX,f,c}(i) of Specification.

In one embodiment, the first power value is P_{CMAX,f,c}(i) of Specification.

In one embodiment, the second power value is P_{CMAX,f,c}(i) of Specification.

In one embodiment, the first power value and the second power value are different.

In one embodiment, the first power value and the second power value are the same.

In one embodiment, the first power value and the second power value are independently configured.

In one embodiment, the first power value and the second power value are both associated to the first reference signal resource set.

In one embodiment, the first power value and the second power value are both one of a first candidate power value and a second candidate power value, and whether the first node is configured with two SRS resource sets is used to determine the first power value and the second power value.

In one subembodiment, the first node is configured with two SRS resource sets for uplink transmission, the first power value is the first candidate power value and the second power value is the second candidate power value.

In one subsidiary embodiment of the above subembodiment, the first candidate power value and the second candidate power value are different.

In one subsidiary embodiment of the above subembodiment, the difference between the first candidate power value and the second candidate power value is equal to 3 dB.

In one subembodiment, the first node is configured with 1 SRS resource set for uplink transmission, the first power value is the first candidate power value and the second power value is the first candidate power value.

In one embodiment, the first power value and the second power value are both one of a first candidate power value and a second candidate power value, and whether the first node uses two SRS resource sets for determining a spatial Tx parameter is used to determine the first power value and the second power value.

In one subembodiment, two SRS resource sets configured for the first node are used to determine a spatial Tx parameter, the first power value is the first candidate power value and the second power value is the second candidate power value.

In one subsidiary embodiment of the above subembodiment, the first candidate power value and the second candidate power value are different.

In one subsidiary embodiment of the above subembodiment, the difference between the first candidate power value and the second candidate power value is equal to 3 dB.

In one subsidiary embodiment of the above subembodiment, the two SRS resource sets being used to determine a spatial Tx parameter means: the two SRS resource sets comprising a first SRS resource and a second SRS resource, respectively, the first SRS resource being associated to a first SRI, the second SRS resource being associated to a second SRI, the first SRI and the second SRI each being used to determine a QCL (i.e., Quasi-Colocated) relationship of two radio signals transmitted by the first node.

In one subsidiary embodiment of the above subembodiment, the two SRS resource sets being used to determine a spatial Tx parameter means: the two SRS resource sets comprising a first SRS resource and a second SRS resource, respectively, and a radio signal transmitted in the first SRS resource and a radio signal transmitted in the second SRS resource being respectively QCL with two radio signals transmitted by the first node.

In one subembodiment, the first node uses one SRS resource set to determine a spatial Tx parameter, the first power value is the first candidate power value and the second power value is the first candidate power value.

In one subsidiary embodiment of the above subembodiment, the one SRS resource set being used to determine a spatial Tx parameter means: the one SRS resource set comprising a first SRS resource, the first SRS resource being associated to a first SRI, the first SRI being used to determine a QCL relationship of one radio signal transmitted by the first node.

In one subsidiary embodiment of the above subembodiment, the one SRS resource set being used to determine a spatial Tx parameter means: the one SRS resource set comprising a first SRS resource, a radio signal transmitted in the first SRS resource being QCL with one radio signal transmitted by the first node.

In one embodiment, the QCL refers to being Quasi Co-Located.

In one embodiment, the QCL refers to Quasi Co-Location.

In one embodiment, the QCL comprises a QCL parameter.

In one embodiment, the QCL comprises a QCL assumption.

In one embodiment, the QCL type includes QCL-Type A.

In one embodiment, the QCL type includes QCL-Type B.

In one embodiment, the QCL type includes QCL-Type C.

In one embodiment, the QCL type includes QCL-Type D.

In one embodiment, the QCL-TypeA comprises Doppler shift, Doppler spread, average delay and delay spread.

In one embodiment, the QCL-TypeB comprises Doppler shift and Doppler spread.

In one embodiment, the QCL-TypeC comprises Doppler shift and average delay.

In one embodiment, the QCL-TypeD comprises Spatial Rx parameter.

In one embodiment, the QCL parameters include at least one of a delay spread, a Doppler spread, a Doppler shift, an average delay, a Spatial Tx parameter or a Spatial Rx parameter.

In one embodiment, the Spatial Tx parameters include at least one of a transmission antenna port, a transmission antenna port group, a transmission analog beamforming matrix, a transmission analog beamforming vector, a transmission beamforming matrix, a transmission beamforming vector or a spatial domain transmission filter.

In one embodiment, the first power difference is measured in dB.

In one embodiment, the second power difference is measured in dB.

In one embodiment, the first power difference is a Power Headroom (PH) for the first reference signal resource.

In one embodiment, the second power difference is a Power Headroom (PH) for the first reference signal resource.

In one embodiment, the first power difference is a PH for the first node while using Single Panel for transmission.

In one embodiment, the second power difference is a PH for the first node while using Double Panels for transmission.

In one embodiment, the first power difference is a corresponding PH for the first node when transmitting a radio signal only on a spatial transmission (Tx) parameter corresponding to one reference signal resource in the first reference signal resource set.

In one embodiment, the second power difference is a corresponding PH for the first node when transmitting radio signals simultaneously on a spatial transmission (Tx) parameter corresponding to one reference signal resource in the first reference signal resource set and a spatial transmission (Tx) parameter corresponding to one reference signal resource in the second reference signal resource set.

In one embodiment, the first power difference is a corresponding PH for the first node when transmitting a radio signal generated by one Transport Block (TB) only on a spatial transmission (Tx) parameter corresponding to one reference signal resource in the first reference signal resource set.

In one embodiment, the second power difference is a corresponding PH for one radio signal when the first node transmits two radio signals generated by two TBs simultaneously on a spatial transmission (Tx) parameter corresponding to one reference signal resource in the first reference signal resource set and a spatial transmission (Tx) parameter corresponding to one reference signal resource in the second reference signal resource set.

In one embodiment, the first target power value is measured in dBm.

In one embodiment, the second target power value is measured in dBm.

In one embodiment, the first target power value is a power value of a radio signal transmitted by the first node in a first time window, the first time window being no later than a start time of transmission of the second information set.

In one subembodiment, the first target power value is a power value of a radio signal transmitted by the first node only on a spatial Tx parameter corresponding to one reference signal resource in the first reference signal resource set.

In one embodiment, the first target power value is a transmission power value of a PUSCH referenced by the first node in a first time window, the first time window being no later than a start time of transmission of the second information set.

In one subembodiment, the first target power value is a power value of a radio signal that the first node assumes to be transmitted only on a spatial Tx parameter corresponding to one reference signal resource in the first reference signal resource set.

In one embodiment, the second target power value is a power value of a radio signal transmitted by the first node in a first time window, the first time window being no later than a start time of transmission of the second information set.

In one subembodiment, the first node transmits two radio signals simultaneously on both a spatial transmission (Tx) parameter corresponding to a first reference signal resource in the first reference signal resource set and a spatial transmission (Tx) parameter corresponding to a second reference signal resource in the second reference signal resource set, and the second target power value is a transmission power value of a radio signal transmitted on the spatial Tx parameter corresponding to the first reference signal resource in the first reference signal resource set.

In one embodiment, the second target power value is a transmission power value of a PUSCH referenced by the first node in a first time window, the first time window being no later than a start time of transmission of the second information set.

In one subembodiment, the first node is assumed to transmit two radio signals simultaneously on both a spatial transmission (Tx) parameter corresponding to a first reference signal resource in the first reference signal resource set and a spatial transmission (Tx) parameter corresponding to a second reference signal resource in the second reference signal resource set, and the second target power value is a transmission power value of a radio signal transmitted on the spatial Tx parameter corresponding to the first reference signal resource in the first reference signal resource set.

In one embodiment, the phrase that the first target power value and the second target power value are both associated to a first reference signal resource in the first reference signal resource set means that the first reference signal resource in the first reference signal resource set is used to determine the first target power value and the second target power value.

In one embodiment, the phrase that the first target power value and the second target power value are both associated to a first reference signal resource in the first reference signal resource set means that the first reference signal resource in the first reference signal resource set is associated to a given CSI-RS resource, the channel quality for a radio signal received in the given CSI-RS resource being used to determine the first target power value and the second target power value.

In one embodiment, the phrase that the first target power value and the second target power value are both associated to a first reference signal resource in the first reference signal resource set means that the first reference signal resource in the first reference signal resource set is associated to a given SSB, the channel quality for a radio signal received in the given SSB being used to determine the first target power value and the second target power value.

In one embodiment, the channel quality in the present application comprises a pathloss.

In one embodiment, the channel quality in the present application comprises a Reference Signal Received Power (RSRP).

In one embodiment, the channel quality in the present application comprises at least one of a Reference Signal Received Quality (RSRQ), a Received Signal Strength Indicator (RSSI), a Signal-to-noise ratio (SNR) or a Signal to Interference plus Noise Ratio (SINR).

In one embodiment, the phrase that the first target power value and the second target power value are for a same cell means that the first target power value and the second target power value are both based on the transmission power value of a PUSCH transmitted in a carrier corresponding to the same cell.

In one embodiment, the phrase that the first target power value and the second target power value are for a same cell means that the first target power value and the second target power value are both based on the transmission power value of a PUSCH transmitted in a carrier corresponding to the same cell.

In one embodiment, the phrase that the first target power value and the second target power value are for a same cell means that a serving cell parameter c corresponding to a radio signal using the first target power value as the transmission power value is the same as a serving cell parameter c corresponding to a radio signal using the second target power value as the transmission power value.

In one embodiment, the phrase that both the first target power value and the second target power value are for a PUSCH means that the first target power value is the transmission power value of the PUSCH and the second target power value is the transmission power value of the PUSCH.

In one embodiment, the phrase that both the first target power value and the second target power value are for a PUSCH means that the first target power value is based on a transmission power value of a reference PUSCH and the second target power value is based on a transmission power value of a reference PUSCH.

In one embodiment, the phrase transmitting a radio signal on a spatial transmission (Tx) parameter corresponding to one reference signal resource in the present application means that the radio signal is QCL with the radio signal transmitted in the reference signal resource.

In one embodiment, the phrase transmitting a radio signal on a spatial transmission (Tx) parameter corresponding to one reference signal resource in the present application means that the radio signal uses the same spatial Tx parameter as the radio signal transmitted in the reference signal resource.

In one embodiment, the first target power value is linearly correlated with a first component, and the second target power value is linearly correlated with a second component: the first component and the second component are each related to an MCS; and the first component is not equal to the second component.

In one subembodiment, the first component is related to a Modulation and Coding Scheme (MCS) of the first signal and the second component is related to a default MCS.

In one subembodiment, the first component is related to a default MCS and the second component is related to an MCS of the first sub-signal.

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology: The EPS 200 may comprise one UE 201, an NR-RAN 202, an Evolved Packet Core (EPC)/5G-Core Network (5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NR-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the EPC/5G-CN 210 via an SI/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE201 corresponds to the first node in the present application.

In one embodiment, the UE201 supports simultaneous transmitting of multiple Panels.

In one embodiment, the UE201 supports multi-Panel-based power sharing.

In one embodiment, the UE201 supports multiple uplink Radio Frequencies (RFs).

In one embodiment, the UE201 supports multiple uplink RFs to be transmitted simultaneously.

In one embodiment, the UE201 supports reporting of multiple UE capability value sets.

In one embodiment, the NR node B corresponds to the second node in the present application.

In one embodiment, the NR node B supports receiving signals from multiple Panels of a terminal simultaneously:

In one embodiment, the NR node B supports receiving signals sent by multiple uplink Radio Frequencies (RFs) from the same terminal.

In one embodiment, the NR node B is a base station.

In one embodiment, the NR node B is a cell.

In one embodiment, the NR node B comprises multiple cells.

In one embodiment, the first node in the present application corresponds to the UE201, and the second node in the present application corresponds to the NR node B.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the second communication node between first communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ).

The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP304 of the second communication node is used for generating scheduling of the first communication node.

In one embodiment, the PDCP354 of the second communication node is used for generating scheduling of the first communication node.

In one embodiment, the first information set is generated by the MAC302 or the MAC352.

In one embodiment, the first information set is generated by the RRC 306.

In one embodiment, the second information set is generated by the MAC302 or the MAC352.

In one embodiment, the second information set is generated by the RRC 306.

In one embodiment, the first signaling is generated by the MAC302 or the MAC352.

In one embodiment, the first signaling is generated by the PHY 301 or the PHY 351.

In one embodiment, the first signal is generated by the MAC302 or the MAC352.

In one embodiment, the first signal is generated by the RRC 306.

In one embodiment, the first signal is generated by the PHY 301 or the PHY 351.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used for managing multiple TRPs.

In one embodiment, the second node is used for managing multiple nodes of cells.

### Embodiment 4

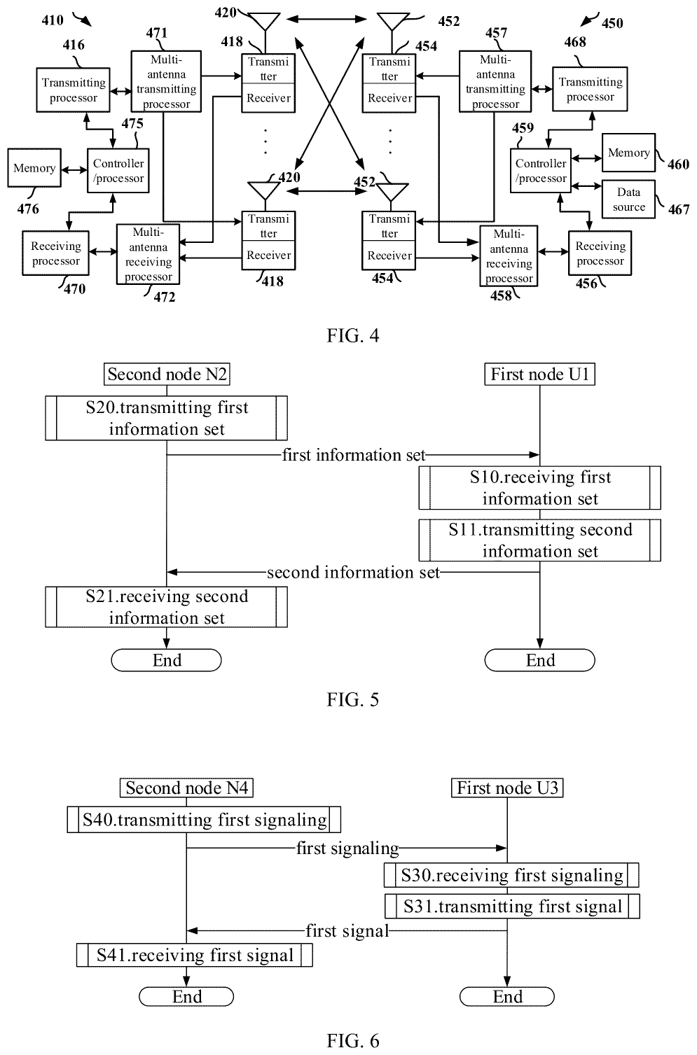

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data: the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data: the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes: the at least one memory and the computer program codes are configured to be used in collaboration with the at least one processor. The first communication device 450 at least firstly receives a first information set, the first information set being used to indicate a first reference signal resource set; and then transmits a second information set: the second information set includes a first power difference and a second power difference: the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a PUSCH.

In one embodiment, the first communication device 450 comprises a memory that stores a computer readable instruction program. The computer readable instruction program generates actions when executed by at least one processor. The actions include: firstly receiving a first information set, the first information set being used to indicate a first reference signal resource set; and then transmitting a second information set: the second information set includes a first power difference and a second power difference: the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a PUSCH.

In one embodiment, the second communication device 410 comprises at least one processor and at least one memory: The at least one memory comprises computer program codes: the at least one memory and the computer program codes are configured to be used in collaboration with the at least one processor. The second communication device 410 at least firstly transmits a first information set, the first information set being used to indicate a first reference signal resource set; and then receives a second information set: the second information set includes a first power difference and a second power difference: the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a PUSCH.

In one embodiment, the second communication device 410 comprises a memory that stores a computer readable instruction program. The computer readable instruction program generates actions when executed by at least one processor. The actions include: firstly transmitting a first information set, the first information set being used to indicate a first reference signal resource set; and then receiving a second information set: the second information set includes a first power difference and a second power difference: the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a PUSCH.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay:

In one embodiment, the second communication device 410 is network equipment.

In one embodiment, the second communication device 410 is a serving cell.

In one embodiment, the second communication device 410 is a TRP.

In one embodiment, at least the first four of the antenna 452, the receiver 454, the multi-antenna receiving processor 458, the receiving processor 456, and the controller/processor 459 are used for receiving a first information set; at least the first four of the antenna 420, the transmitter 418, the multi-antenna transmitting processor 471, the transmitting processor 416 and the controller/processor 475 are used for transmitting a first information set.

In one embodiment, at least the first four of the antenna 452, the receiver 454, the multi-antenna receiving processor 458, the receiving processor 456, and the controller/processor 459 are used for transmitting a second information set: at least the first four of the antenna 420, the transmitter 418, the multi-antenna transmitting processor 471, the transmitting processor 416 and the controller/processor 475 are used for receiving a second information set.

In one embodiment, at least the first four of the antenna 452, the receiver 454, the multi-antenna receiving processor 458, the receiving processor 456, and the controller/processor 459 are used for receiving a first signaling: at least the first four of the antenna 420, the transmitter 418, the multi-antenna transmitting processor 471, the transmitting processor 416 and the controller/processor 475 are used for transmitting a first signaling.

In one embodiment, at least the first four of the antenna 452, the transmitter 454, the multi-antenna transmitting processor 457, the transmitting processor 468 and the controller/processor 459 are used to transmit a first signal: at least the first four of the antenna 420, the receiver 418, the multi-antenna receiving processor 472, the receiving processor 470 and the controller/processor 475 are used to receive a first signal.

### Embodiment 5

Embodiment 5 illustrates a flowchart of a first information set, as shown in FIG. 5. In FIG. 5, a first node U1 and a second node N2 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 5 can be applied to any of Embodiments 6, 7 or 8: conversely, in case of no conflict, the embodiments, sub-embodiments, and subsidiary embodiments in any of Embodiments 6, 7 or 8 can be applied to Embodiment 5.

The first node U1 receives a first information set in step S10; and transmits a second information set in step S11.

The second node N2 transmits a first information set in step S20; and receives a second information set in step S21.

In Embodiment 5, the second information set includes a first power difference and a second power difference: the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a PUSCH.

Typically, the first information set is used to indicate a second reference signal resource set: the second information set includes a third power difference and a fourth power difference: the third power difference is equal to a difference obtained by subtracting a third target power value from a third power value, and the fourth power difference is equal to a difference obtained by subtracting a fourth target power value from a fourth power value: the third target power value and the fourth target power value are both associated to a second reference signal resource in the second reference signal resource set: the third target power value and the fourth target power value are for a same cell, and both the third target power value and the fourth target power value are for a PUSCH.

In one embodiment, the second reference signal resource set is identified by an SRS-ResourceSetId.

In one embodiment, the second reference signal resource set corresponds to an SRS Resource Set.

In one embodiment, the first reference signal resource set and the second reference signal resource set are each identified by a different SRS-ResourceSetId.

In one embodiment, the second reference signal resource set comprises one reference signal resource.

In one subembodiment, the reference signal resource included in the second reference signal resource set is an SRS Resource.

In one subembodiment, the reference signal resource included in the second reference signal resource set is a CSI-RS resource.

In one subembodiment, the reference signal resource included in the second reference signal resource set is an SSB.

In one embodiment, the second reference signal resource set comprises K2 reference signal resources, K2 being a positive integer greater than 1.

In one subembodiment, any one of the K2 reference signal resources included in the second reference signal resource set is an SRS Resource.

In one subembodiment, at least one of the K2 reference signal resources included in the second reference signal resource set is an SRS Resource.

In one subembodiment, any one of the K2 reference signal resources included in the second reference signal resource set is a CSI-RS resource.

In one subembodiment, any one of the K2 reference signal resources included in the second reference signal resource set is an SSB.

In one embodiment, the third power value is measured in dBm.

In one embodiment, the fourth power value is measured in dBm.

In one embodiment, the third power value is measured in dB.

In one embodiment, the fourth power value is measured in dB.

In one embodiment, the third power value is measured in mW.

In one embodiment, the fourth power value is measured in mW.

In one embodiment, the third power value is P_{CMAX,f,c}(i) of Specification.

In one embodiment, the fourth power value is P_{CMAX,f,c}(i) of Specification.

In one embodiment, the third power value is P_{CMAX,f,c}(i) of Specification.

In one embodiment, the fourth power value is P_{CMAX,f,c}(i) of Specification.

In one embodiment, the third power value and the fourth power value are different.

In one embodiment, the third power value and the fourth power value are the same.

In one embodiment, the third power value and the fourth power value are independently configured.

In one embodiment, the third power value and the fourth power value are both associated to the first reference signal resource set.

In one embodiment, the third power value and the fourth power value are both one of a third candidate power value and a fourth candidate power value, and whether the first node is configured with two SRS resource sets is used to determine the third power value and the fourth power value.

In one subembodiment, the first node is configured with two SRS resource sets for uplink transmission, the third power value is the third candidate power value and the fourth power value is the fourth candidate power value.

In one subsidiary embodiment of the above subembodiment, the third candidate power value and the fourth candidate power value are different.

In one subsidiary embodiment of the above subembodiment, the difference between the third candidate power value and the fourth candidate power value is equal to 3 dB.

In one subembodiment, the first node is configured with 1 SRS resource set for uplink transmission, the third power value is the third candidate power value, and the fourth power value is the third candidate power value.

In one embodiment, the third power value and the fourth power value are both one of a third candidate power value and a fourth candidate power value, and whether the first node uses two SRS resource sets for determining a spatial Tx parameter is used to determine the third power value and the fourth power value.

In one subembodiment, two SRS resource sets configured for the first node are used to determine a spatial Tx parameter, the third power value is the third candidate power value and the fourth power value is the fourth candidate power value.

In one subsidiary embodiment of the above subembodiment, the third candidate power value and the fourth candidate power value are different.

In one subsidiary embodiment of the above subembodiment, the difference between the third candidate power value and the fourth candidate power value is equal to 3 dB.

In one subsidiary embodiment of the above subembodiment, the two SRS resource sets being used to determine a spatial Tx parameter means: the two SRS resource sets comprising a first SRS resource and a second SRS resource, respectively, the first SRS resource being associated to a first SRI, the second SRS resource being associated to a second SRI, the first SRI and the second SRI each being used to determine a QCL relationship of two radio signals transmitted by the first node.

In one subsidiary embodiment of the above subembodiment, the two SRS resource sets being used to determine a spatial Tx parameter means: the two SRS resource sets comprising a first SRS resource and a second SRS resource, respectively, and a radio signal transmitted in the first SRS resource and a radio signal transmitted in the second SRS resource being respectively QCL with two radio signals transmitted by the first node.

In one subembodiment, the first node uses one SRS resource set to determine a spatial Tx parameter, the third power value is the third candidate power value and the fourth power value is the third candidate power value.

In one subsidiary embodiment of the above subembodiment, the one SRS resource set being used to determine a spatial Tx parameter means: the one SRS resource set comprising a first SRS resource, the first SRS resource being associated to a first SRI, the first SRI being used to determine a QCL relationship of one radio signal transmitted by the first node.

In one subsidiary embodiment of the above subembodiment, the one SRS resource set being used to determine a spatial Tx parameter means: the one SRS resource set comprising a first SRS resource, a radio signal transmitted in the first SRS resource being QCL with one radio signal transmitted by the first node.

In one embodiment, the third power difference is measured in dB.

In one embodiment, the fourth power difference is measured in dB.

In one embodiment, the third power difference is a PH for the second reference signal resource.

In one embodiment, the fourth power difference is a PH for the second reference signal resource.

In one embodiment, the third power difference is a PH for the first node while using Single Panel for transmission.

In one embodiment, the fourth power difference is a PH for the first node while using Double Panels for transmission.

In one embodiment, the third power difference is a corresponding PH for the first node when transmitting a radio signal only on a spatial transmission (Tx) parameter corresponding to one reference signal resource in the first reference signal resource set.

In one embodiment, the fourth power difference is a corresponding PH for the first node when transmitting radio signals simultaneously on a spatial transmission (Tx) parameter corresponding to one reference signal resource in the first reference signal resource set and a spatial transmission (Tx) parameter corresponding to one reference signal resource in the second reference signal resource set.

In one embodiment, the third power difference is a corresponding PH for the first node when transmitting a radio signal generated by one TB only on a spatial transmission (Tx) parameter corresponding to one reference signal resource in the second reference signal resource set.

In one embodiment, the fourth power difference is a corresponding PH for one radio signal when the first node transmits two radio signals generated by two TBs simultaneously on a spatial transmission (Tx) parameter corresponding to one reference signal resource in the first reference signal resource set and a spatial transmission (Tx) parameter corresponding to one reference signal resource in the second reference signal resource set.

In one embodiment, the third target power value is measured in dBm.

In one embodiment, the fourth target power value is measured in dBm.

In one embodiment, the third target power value is a power value of a radio signal transmitted by the first node in a first time window, the first time window being no later than a start time of transmission of the second information block.

In one subembodiment, the third target power value is a power value of a radio signal transmitted by the first node only on a spatial Tx parameter corresponding to one reference signal resource in the second reference signal resource set.

In one embodiment, the third target power value is a transmission power value of a PUSCH referenced by the first node in a first time window, the first time window being no later than a start time of transmission of the second information block.

In one subembodiment, the third target power value is a power value of a radio signal that the first node assumes to be transmitted only on a spatial Tx parameter corresponding to one reference signal resource in the second reference signal resource set.

In one embodiment, the fourth target power value is a power value of a radio signal transmitted by the first node in a first time window, the first time window being no later than a start time of transmission of the second information block.

In one subembodiment, the first node transmits two radio signals simultaneously on both a spatial transmission (Tx) parameter corresponding to a first reference signal resource in the first reference signal resource set and a spatial transmission (Tx) parameter corresponding to a second reference signal resource in the second reference signal resource set, and the fourth target power value is a transmission power value of a radio signal transmitted on the spatial Tx parameter corresponding to the second reference signal resource in the second reference signal resource set.

In one embodiment, the fourth target power value is a transmission power value of a PUSCH referenced by the first node in a first time window, the first time window being no later than a start time of transmission of the third information block.

In one subembodiment, the first node is assumed to transmit two radio signals simultaneously on both a spatial transmission (Tx) parameter corresponding to a first reference signal resource in the first reference signal resource set and a spatial transmission (Tx) parameter corresponding to a second reference signal resource in the second reference signal resource set, and the fourth target power value is a transmission power value of a radio signal transmitted on the spatial Tx parameter corresponding to the second reference signal resource in the second reference signal resource set.

In one embodiment, the phrase that the third target power value and the fourth target power value are both associated to a second reference signal resource in the second reference signal resource set means that the second reference signal resource in the second reference signal resource set is used to determine the third target power value and the fourth target power value.

In one embodiment, the phrase that the third target power value and the fourth target power value are both associated to a second reference signal resource in the second reference signal resource set means that the second reference signal resource in the second reference signal resource set is associated to a given CSI-RS resource, the channel quality for a radio signal received in the given CSI-RS resource being used to determine the third target power value and the fourth target power value.

In one embodiment, the phrase that the third target power value and the fourth target power value are both associated to a second reference signal resource in the second reference signal resource set means that the second reference signal resource in the second reference signal resource set is associated to a given SSB, the channel quality for a radio signal received in the given SSB being used to determine the third target power value and the fourth target power value.

In one embodiment, the phrase that the third target power value and the fourth target power value are for a same cell means that the third target power value and the fourth target power value are both based on the transmission power value of a PUSCH transmitted in a carrier corresponding to the same cell.

In one embodiment, the phrase that the third target power value and the fourth target power value are for a same cell means that the third target power value and the fourth target power value are both based on the transmission power value of a PUSCH transmitted in a carrier corresponding to the same cell.

In one embodiment, the phrase that the third target power value and the fourth target power value are for a same cell means that a serving cell parameter c corresponding to a radio signal using the third target power value as the transmission power value is the same as a serving cell parameter c corresponding to a radio signal using the fourth target power value as the transmission power value.

In one embodiment, the phrase that both the third target power value and the fourth target power value are for a PUSCH means that the third target power value is the transmission power value of the PUSCH and the fourth target power value is the transmission power value of the PUSCH.

In one embodiment, the phrase that both the third target power value and the fourth target power value are for a PUSCH means that the third target power value is based on a transmission power value of a reference PUSCH and the fourth target power value is based on a transmission power value of a reference PUSCH.

In one embodiment, the third target power value is linearly correlated with a third component, and the fourth target power value is linearly correlated with a fourth component: the third component and the fourth component are each related to an MCS; and the third component is not equal to the fourth component.

In one subembodiment, the third component is related to an MCS of the first signal and the fourth component is related to a default MCS.

In one subembodiment, the third component is related to a default MCS and the fourth component is related to an MCS of the second sub-signal.

Typically, the first power value and the second power value are both associated to the first reference signal resource set, while the third power value and the fourth power value are both associated to the second reference signal resource set: the first power value is different from the second power value, and the third power value is different from the fourth power value.

In one embodiment, the phrase that the first power value and the second power value are both associated to the first reference signal resource set means that both the first power value and the second power value are used to determine a transmission power value of a radio signal that is QCL with any reference signal resource in the first reference signal resource set.

In one embodiment, the phrase that the first power value and the second power value are both associated to the first reference signal resource set means that both the first power value and the second power value are used to determine a transmission power value of a radio signal that is QCL with the first reference signal resource in the first reference signal resource set.

In one embodiment, the phrase that the first power value and the second power value are both associated to the first reference signal resource set means that both the first power value and the second power value are used to determine a transmission power value of a radio signal that is QCL with at least one reference signal resource in the first reference signal resource set.

In one embodiment, the phrase that the first power value and the second power value are both associated to the first reference signal resource set means that both the first power value and the second power value are used to determine a P_{CMAX} of a radio signal that is QCL with any reference signal resource in the first reference signal resource set.

In one embodiment, the phrase that the first power value and the second power value are both associated to the first reference signal resource set means that both the first power value and the second power value are used to determine a P_{CMAX} of a radio signal that is QCL with the first reference signal resource in the first reference signal resource set.

In one embodiment, the phrase that the first power value and the second power value are both associated to the first reference signal resource set means that both the first power value and the second power value are used to determine a P_{CMAX} of a radio signal that is QCL with at least one reference signal resource in the first reference signal resource set.

In one embodiment, the first power value is used to determine a transmission power value of a given radio signal, and the given radio signal is QCL with only one reference signal resource in the first reference signal resource set.

In one embodiment, the second power value is used to determine a transmission power value of a given radio signal, and the given radio signal comprises two radio sub-signals; the two radio sub-signals are respectively QCL with one reference signal resource in the first reference signal resource set and QCL with one reference signal resource in the second reference signal resource set.

In one subembodiment, the second power value is used to determine a transmission power value of one radio sub-signal of the two radio sub-signals that is QCL with one reference signal resource in the first reference signal resource set.

In one embodiment, the phrase that the third power value and the fourth power value are both associated to the second reference signal resource set means that both the third power value and the fourth power value are used to determine a transmission power value of a radio signal that is QCL with any reference signal resource in the second reference signal resource set.

In one embodiment, the phrase that the third power value and the fourth power value are both associated to the second reference signal resource set means that both the third power value and the fourth power value are used to determine a transmission power value of a radio signal that is QCL with the second reference signal resource in the second reference signal resource set.

In one embodiment, the phrase that the third power value and the fourth power value are both associated to the second reference signal resource set means that both the third power value and the fourth power value are used to determine a transmission power value of a radio signal that is QCL with at least one reference signal resource in the second reference signal resource set.

In one embodiment, the phrase that the third power value and the fourth power value are both associated to the second reference signal resource set means that both the third power value and the fourth power value are used to determine a P_{CMAX} of a radio signal that is QCL with any reference signal resource in the second reference signal resource set.

In one embodiment, the phrase that the third power value and the fourth power value are both associated to the second reference signal resource set means that both the third power value and the fourth power value are used to determine a P_{CMAX} of a radio signal that is QCL with the second reference signal resource in the second reference signal resource set.

In one embodiment, the phrase that the third power value and the fourth power value are both associated to the second reference signal resource set means that both the third power value and the fourth power value are used to determine a P_{CMAX} of a radio signal that is QCL with at least one reference signal resource in the second reference signal resource set.

In one embodiment, the third power value is used to determine a transmission power value of a given radio signal, and the given radio signal is QCL with only one reference signal resource in the second reference signal resource set.

In one embodiment, the fourth power value is used to determine a transmission power value of a given radio signal, and the given radio signal comprises two radio sub-signals: the two radio sub-signals are respectively QCL with one reference signal resource in the first reference signal resource set and QCL with one reference signal resource in the second reference signal resource set.

In one subembodiment, the fourth power value is used to determine a transmission power value of one radio sub-signal of the two radio sub-signals that is QCL with one reference signal resource in the second reference signal resource set.

Typically, a first value and a second value are both associated to the first reference signal resource set, and a first coefficient and a second coefficient are both associated to the first reference signal resource set: the first value and the first coefficient are used to determine the first target power value, while the second value and the second coefficient are used to determine the second target power value: the first value and the second value are of a same type, and the first coefficient and the second coefficient are of a same type.

In one embodiment, the first value is measured in dBm.

In one embodiment, the first value is a P0.

In one embodiment, the second value is measured in dBm.

In one embodiment, the second value is a P0.

In one embodiment, both the first value and the second value are associated to a reference signal resource in the first reference signal resource set.

In one embodiment, both the first value and the second value are associated to a first reference signal resource in the first reference signal resource set.

In one embodiment, the first target power value is not greater than the first power value, and the first value is linearly correlated with the first target power value.

In one subembodiment, a linear coefficient of the first value to the first target power value is equal to 1.

In one embodiment, the second target power value is not greater than the second power value, and the second value is linearly correlated with the second target power value.

In one subembodiment, a linear coefficient of the second value to the second target power value is equal to 1.

In one embodiment, the first coefficient is no greater than 1.

In one embodiment, the first coefficient is a real number between 0 and 1.

In one embodiment, the second coefficient is no greater than 1.

In one embodiment, the second coefficient is a real number between 0 and 1.

In one embodiment, the first coefficient is different from the second coefficient.

In one embodiment, the first coefficient is the same as the second coefficient.

In one embodiment, the first coefficient is independent of the second coefficient.

In one embodiment, the first coefficient is related to the second coefficient.

In one embodiment, the first coefficient is independently configured from the second coefficient.

In one embodiment, the first coefficient is jointly configured with the second coefficient.

In one embodiment, when the first signaling is used to indicate at least one reference signal resource in the second reference signal resource set, the first signal comprises a first sub-signal and a second sub-signal, and a product of the second coefficient and the first pathloss is used to determine a transmission power value of the first sub-signal: when the first signaling is not used to indicate any reference signal resource in the second reference signal resource set, a product of the first coefficient and the first pathloss is used to determine a transmission power value of the first signal: a reference signal resource in the first reference signal resource set that is indicated by the first signaling is used to determine a third reference signal resource: a radio signal received in the third reference signal resource is used to determine the first pathloss.

In one embodiment, the third reference signal resource is a CSI-RS resource.

In one embodiment, the third reference signal resource is an SSB.

In one embodiment, a first reference signal resource in the first reference signal resource set is indicated by the first signaling, and the first reference signal resource is used to determine the third reference signal resource.

In one subembodiment, a radio signal transmitted in the first reference signal resource and a radio signal transmitted in the third reference signal resource are QCL.

In one subembodiment, a ssb-Index or csi-RS-Index corresponding to the third reference signal resource is associated to a pusch-PathlossReferenceRS-Id corresponding to the first reference signal resource.

In one embodiment, the first pathloss is measured in dB.

In one embodiment, the second pathloss is measured in dB.

In one embodiment, when a product of the second coefficient and the first pathloss is used to determine a transmission power value of the first sub-signal and the transmission power value of the first sub-signal is not greater than the second power value, the product of the second coefficient and the first pathloss is linearly correlated with the transmission power value of the first sub-signal.

In one subembodiment, the linear coefficient between the product of the second coefficient and the first pathloss and the transmission power value of the first sub-signal is equal to 1.

In one embodiment, when a product of the first coefficient and the first pathloss is used to determine a transmission power value of the first signal and the transmission power value of the first signal is not greater than the first power value, the product of the first coefficient and the first pathloss is linearly correlated with the transmission power value of the first signal.

In one subembodiment, the linear coefficient between the product of the first coefficient and the first pathloss and the transmission power value of the first signal is equal to 1.

In one embodiment, the first value is P0 in TS 38.331.

In one embodiment, the first coefficient is Alpha in TS 38.331.

In one embodiment, the second value is P0 in TS 38.331.

In one embodiment, the second coefficient is Alpha in TS 38.331.

### Embodiment 6

Embodiment 6 illustrates a flowchart of a first signaling, as shown in FIG. 6. In FIG. 6, a first node U3 and a second node N4 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 6 can be applied to any of Embodiments 5, 7 or 8: conversely, in case of no conflict, the embodiments, sub-embodiments, and subsidiary embodiments in any of Embodiments 5, 7 or 8 can be applied to Embodiment 6.

The first node U3 receives a first signaling in step S30; and transmits a first signal in step S31.

The second node N4 transmits a first signaling in step S40; and receives a first signal in step S41.

In Embodiment 6, the first signaling is used to determine the first reference signal resource, and the first reference signal resource is used to determine a spatial transmission (Tx) parameter for the first signal, a transmission power value of the first signal being equal to the first target power value.

In one embodiment, time-domain resources occupied by the first signal are located in the first time window of the present application.

In one embodiment, time-domain resources occupied by the first signaling are located in the first time window of the present application.

In one embodiment, a physical layer channel occupied by the first signaling includes a PDCCH.

In one embodiment, the first signaling is DCI.

In one embodiment, a physical layer channel occupied by the first signal includes a PUSCH.

In one embodiment, the first signaling is used for scheduling the first signal.

In one embodiment, the first signaling is used to indicate frequency-domain resources occupied by the first signal.

In one embodiment, the first signaling is used to indicate time-domain resources occupied by the first signal.

In one embodiment, the first signaling is used to indicate the first reference signal resource.

In one embodiment, the first signaling is used to indicate the first reference signal resource in the first reference signal resource set.

In one embodiment, a radio signal transmitted in the first reference signal resource is QCL with the first signal.

In one embodiment, the first signaling is only used to indicate the first reference signal resource in the first reference signal resource set, and the first signaling is not used to indicate the second reference signal resource in the second reference signal resource set.

In one embodiment, the first signal is generated by one TB.

In one embodiment, the first signal is a radio signal.

In one embodiment, the first signal is a baseband signal.

In one embodiment, the first time window in the present application comprises 1 slot.

In one embodiment, the first time window in the present application comprises multiple consecutive slots.

In one embodiment, the first signal comprises the second information set.

In one embodiment, the step S31 is the same step as the step S11 in Embodiment 5.

In one embodiment, the step S41 is the same step as the step S21 in Embodiment 5.

In one embodiment, the step S30 is located after the step S10 and before the step S11 in Embodiment 5.

In one embodiment, the step S40 is located after the step S20 and before the step S21 in Embodiment 5.

In one embodiment, the step S31 is located before the step S11 in Embodiment 5.

In one embodiment, the step S41 is located before the step S21 in Embodiment 5.

### Embodiment 7

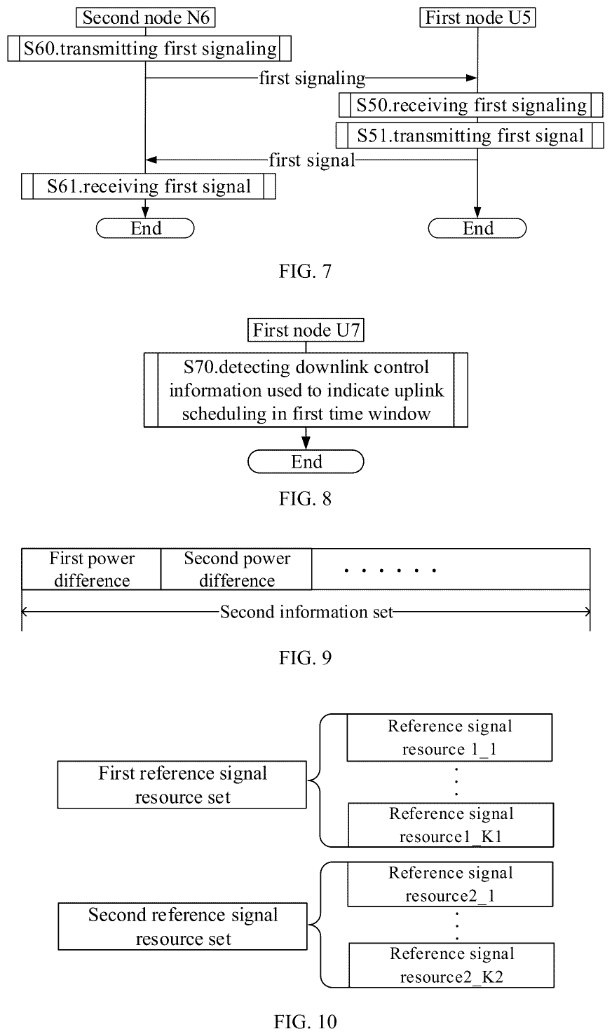

Embodiment 7 illustrates another flowchart of a first signaling, as shown in FIG. 7. In FIG. 7, a first node U5 and a second node N6 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 7 can be applied to any of Embodiments 5, 6 or 8; conversely, in case of no conflict, the embodiments, sub-embodiments, and subsidiary embodiments in any of Embodiments 5, 6 or 8 can be applied to Embodiment 7.

The first node U5 receives a first signaling in step S50; and transmits a first signal in step S51.

The second node N6 transmits a first signaling in step S60; and receives a first signal in step S61.

In Embodiment 7, the first signaling is used to determine the first reference signal resource and the second reference signal resource, and the first signal comprises a first sub-signal and a second sub-signal; the first reference signal resource is used to determine a spatial transmission (Tx) parameter for the first sub-signal, while the second reference signal resource is used to determine a spatial Tx parameter for the second sub-signal; a transmission power value of the first sub-signal is equal to the second target power value, and a transmission power value of the second sub-signal is equal to the fourth target power value.

In one embodiment, time-domain resources occupied by the first signal are located in the first time window of the present application.

In one embodiment, time-domain resources occupied by the first signaling are located in the first time window of the present application.

In one embodiment, a physical layer channel occupied by the first signaling includes a PDCCH.

In one embodiment, the first signaling is DCI.

In one embodiment, a physical layer channel occupied by the first signal includes a PUSCH.

In one embodiment, the first signaling is used for scheduling the first signal.

In one embodiment, the first signaling is used to indicate frequency-domain resources occupied by the first signal.

In one embodiment, the first signaling is used to indicate time-domain resources occupied by the first signal.

In one embodiment, the first signaling is used to indicate the first reference signal resource and the second reference signal resource.

In one embodiment, the first signaling is used to indicate the first reference signal resource in the first reference signal resource set, and the first signaling is used to indicate the second reference signal resource in the second reference signal resource set.

In one embodiment, a radio signal transmitted in the first reference signal resource is QCL with the first sub-signal, and a radio signal transmitted in the second reference signal resource is QCL with the second sub-signal.

In one embodiment, the first signal is generated by 2 TBs, the 2 TBs being used to generate the first sub-signal and the second sub-signal, respectively:

In one embodiment, the step S51 is the same step as the step S11 in Embodiment 5.

In one embodiment, the step S61 is the same step as the step S21 in Embodiment 5.

In one embodiment, the step S50 is located after the step S10 and before the step S11 in Embodiment 5.

In one embodiment, the step S60 is located after the step S20 and before the step S21 in Embodiment 5.

In one embodiment, the step S51 is located before the step S11 in Embodiment 5.

In one embodiment, the step S61 is located before the step S21 in Embodiment 5.

### Embodiment 8

Embodiment 8 illustrates a flowchart of downlink control information, as shown in FIG. 8. In FIG. 8, the first node U7 detects downlink control information from the second node N8, but the second node N8 does not transmit any downlink control information used for uplink scheduling for the first node in the first time window. It should be particularly noted that the sequence illustrated herein does not set any limit to the signal transmission order or implementation order in the present application. In case of no conflict, the embodiments, sub-embodiments, and subsidiary embodiments in Embodiment 8 can be applied to any of Embodiments 5, 6 or 7; conversely; in case of no conflict, the embodiments, sub-embodiments, and subsidiary embodiments in any of Embodiments 5, 6 or 7 can be applied to Embodiment 8.

The first node U7 detects in step S70 downlink control information used to indicate uplink scheduling in a first time window.

In Embodiment 8, the first node has not detected any downlink control information used to indicate uplink scheduling for the first node in a first time window; the uplink scheduling includes a physical uplink shared channel, and a power control parameter associated with the first reference signal resource is pre-defined.

In one embodiment, the meaning of the above phrase “a power control parameter associated with the first reference signal resource is pre-defined” comprises that j of P_{O_NOMINAL_PUSCH,f,c}(j) associated with the first reference signal resource is equal to 0.

In one embodiment, the meaning of the above phrase “a power control parameter associated with the first reference signal resource is pre-defined” comprises: the PUSCH-AlphaSetId associated with the first reference signal resource is equal to 0.

In one embodiment, the meaning of the above phrase “a power control parameter associated with the first reference signal resource is pre-defined” comprises: the pusch-PathlossReferenceRS-Id associated with the first reference signal resource adopted for obtaining a pathloss is equal to 0.

In one embodiment, the meaning of the above phrase “a power control parameter associated with the first reference signal resource is pre-defined” comprises: an index corresponding to the first reference signal resource is the smallest of indexes corresponding to any of the reference signal resources included in the first reference signal resource set.

In one embodiment, an index of the first reference signal resource in the first reference signal resource set is an SRI.

In one embodiment, the step S70 is located after the step S10 and before the step S11 in Embodiment 5.

### Embodiment 9

Embodiment 9 illustrates a schematic diagram of a second information set, as shown in FIG. 9. In FIG. 9, the second information set comprises a first power difference and a second power difference.

In one embodiment, the second information set comprises the third power difference and the fourth power difference in this application.

In one embodiment, the second information set comprises the first power difference, the second power difference, the third power difference and the fourth power difference in this application.

In one embodiment, the second information set comprises the first power value of this application.

In one embodiment, the second information set comprises the second power value of this application.

In one embodiment, the second information set comprises the third power value of this application.

In one embodiment, the second information set comprises the fourth power value of this application.

In one embodiment, the second information set comprises a first field, the first field being used to indicate a ServCellIndex of a serving cell to which a given power difference corresponds, the given power difference being any one of the first power difference, the second power difference, the third power difference and the fourth power difference.

In one embodiment, the second information set comprises a second field, the second field being used to indicate whether a given power difference is based on an actual transmission or a Reference Format, the given power difference being any one of the first power difference, the second power difference, the third power difference and the fourth power difference.

In one embodiment, the second information set comprises a third field, the third field being used to indicate whether a reference signal resource set associated with a given power difference is the first reference signal resource set or the second reference signal resource set, the given power difference being any one of the first power difference, the second power difference, the third power difference and the fourth power difference.

In one embodiment, the second information set comprises a fourth field, the fourth field being used to indicate whether a given power difference is based on the use of one of the first reference signal resource set or the second reference signal resource set, or is based on the use of both the first reference signal resource set and the second reference signal resource set, the given power difference being any one of the first power difference, the second power difference, the third power difference and the fourth power difference.

In one embodiment, corresponding to the ServCellIndex of a given serving cell, relative positions of the first power difference, the second power difference, the third power difference and the fourth power difference are fixed.

### Embodiment 10

Embodiment 10 illustrates a schematic diagram of a first reference signal resource set and a second reference signal resource set, as shown in FIG. 10. In FIG. 10, the first reference signal resource set comprises K1 reference signal resource(s) corresponding to reference signal resource 1_1 to reference signal resource 1_K1 in the figure, respectively; the second reference signal resource set comprises K2 reference signal resource(s) corresponding to reference signal resource 2_1 to reference signal resource 2_K2 in the figure, respectively: K1 is a positive integer and K2 is a positive integer.

In one embodiment, K1 is equal to 1, and the first reference signal resource set includes only the first reference signal resource in the present application.

In one embodiment, K2 is equal to 1, and the second reference signal resource set includes only the second reference signal resource in the present application.

In one embodiment, K1 is greater than 1.

In one embodiment, K2 is greater than 1.

In one embodiment, the first value applies to all reference signal resources in the first reference signal resource set.

In one embodiment, the first value applies to a first reference signal resource in the first reference signal resource set.

In one embodiment, the second value applies to all reference signal resources in the first reference signal resource set.

In one embodiment, the second value applies to a first reference signal resource in the first reference signal resource set.

In one embodiment, the first coefficient applies to all reference signal resources in the first reference signal resource set.

In one embodiment, the first coefficient applies to a first reference signal resource in the first reference signal resource set.

In one embodiment, the second coefficient applies to all reference signal resources in the first reference signal resource set.

In one embodiment, the second coefficient applies to a first reference signal resource in the first reference signal resource set.

In one embodiment, the first power value applies to all reference signal resources in the first reference signal resource set.

In one embodiment, the first power value applies to a first reference signal resource in the first reference signal resource set.

In one embodiment, the second power value applies to all reference signal resources in the first reference signal resource set.

In one embodiment, the second power value applies to a first reference signal resource in the first reference signal resource set.

In one embodiment, the first reference signal resource set and the second reference signal resource set respectively correspond to two different Panel IDs.

In one embodiment, the first reference signal resource set and the second reference signal resource set respectively correspond to two Panels included in the first node.

In one embodiment, the first reference signal resource set and the second reference signal resource set respectively correspond to two Radio Frequencies (RFs) included in the first node.

In one embodiment, the first reference signal resource set and the second reference signal resource set respectively correspond to two RF channels included in the first node.

### Embodiment 11

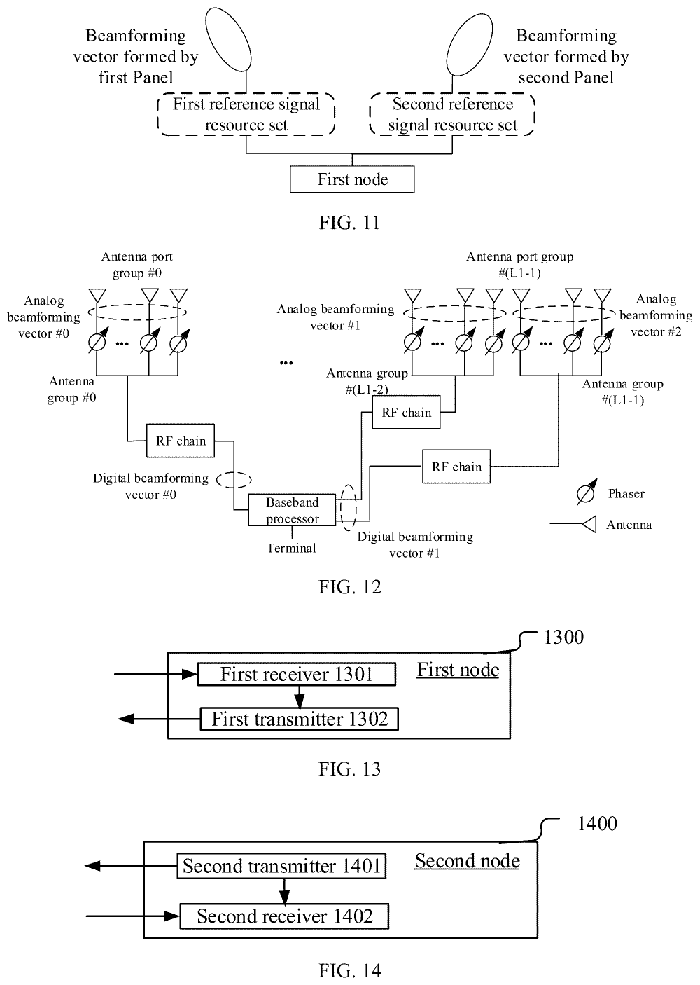

Embodiment 11 illustrates a schematic of a first node, as shown in FIG. 11. In FIG. 11, the first node has two Panels, i.e., a first Panel and a second Panel, the first Panel and the second Panel being associated to a first reference signal resource set and a second reference signal resource set, respectively; and the two Panels are capable of transmitting two independent radio signals in the same block of time-frequency resource.

In one embodiment, the first Panel and the second Panel can dynamically share a maximum transmission power value between each other.

In one embodiment, when the first Panel or the second Panel is used individually, a maximum transmission power value of the first Panel or the second Panel is not greater than a first threshold in this application.

In one embodiment, when the first Panel and the second Panel are used together, a maximum transmission power value of the first Panel and a maximum transmission power value of the second Panel are not greater than a second threshold and a third threshold in this application, respectively.

### Embodiment 12

Embodiment 12 illustrates a schematic diagram of antennas and antenna port groups, as shown in FIG. 12.

In Embodiment 12, an antenna port group consists of a positive integer number of antenna port(s): an antenna port is formed by superimposing antennas in a positive integer number of antenna group(s) through Antenna Virtualization. One antenna group is connected to a baseband processor through a Radio Frequency (RF) chain, so each antenna group corresponds to a different RF chain. Mapping coefficients of all antennas in a positive integer number of antenna group(s) comprised by a given antenna port to the given antenna port constitute a beamforming vector corresponding to the given antenna port. Mapping coefficients of multiple antennas comprised in any given one of a positive integer number of antenna groups comprised by the given antenna port to the given antenna port constitute an analog beamforming vector for the given antenna port. Analog beamforming vectors respectively corresponding to the positive integer number of antenna groups are diagonally arranged to form an analog beamforming matrix corresponding to the given antenna port. Mapping coefficients of the positive integer number of antenna groups to the given antenna port constitute a digital beamforming vector corresponding to the given antenna port. A beamforming vector corresponding to the given antenna port is a product of the analog beamforming matrix and the digital beamforming vector respectively corresponding to the given antenna port. Each antenna port in antenna port group is composed of (a) same antenna group(s), and different antenna ports in a same antenna port group correspond to different beamforming vectors.

FIG. 12 illustrates two antenna port groups, which are antenna port group #0 and antenna port group #1. Herein, the antenna port group is composed of antenna group #0, while the antenna port group #1 is composed of antenna group #1 and antenna group #2. Mapping coefficients of multiple antennas comprised in the antenna group #0 to the antenna port group #0 constitute an analog beamforming vector #0: a mapping coefficient of the antenna group #0 to the antenna port group #0 constitute a digital beamforming vector #0. Mapping coefficients of multiple antennas comprised in the antenna group #1 to the antenna port group #1 and mapping coefficients of multiple antennas comprised in the antenna group #2 to the antenna port group #1 respectively constitute an analog beamforming vector #1 and an analog beamforming vector #2: respective mapping coefficients of the antenna group #1 and the antenna group #2 to the antenna port group #1 constitute a digital beamforming vector #1. A beamforming vector corresponding to any antenna port comprised by the antenna port group #0 is a product of the analog beamforming vector #0 and the digital beamforming vector #0. A beamforming vector corresponding to any antenna port comprised by the antenna port group #1 is a product of the digital beamforming vector #1 and an analog beamforming matrix formed by diagonally arrangement of the analog beamforming vector #1 and the analog beamforming vector #2.

In one subembodiment, an antenna port group comprises one antenna port. For example, the antenna port group #0 in FIG. 12 comprises one antenna port.

In one subsidiary embodiment of the above subembodiment, an analog beamforming matrix corresponding to the one antenna port is dimensionally reduced to an analog beamforming vector, while a digital beamforming vector corresponding to the one antenna port is dimensionally reduced to a scaler, a beamforming vector corresponding to the one antenna port is equivalent to an analog beamforming vector corresponding to the one antenna port.

In one subembodiment, an antenna port group comprises multiple antenna ports. For example, the antenna port group #1 in FIG. 12 comprises multiple antenna ports.

In one subsidiary embodiment of the above subembodiment, the multiple antenna ports correspond to a same analog beamforming matrix and different digital beamforming vectors.

In one subembodiment, antenna ports in different antenna port groups correspond to different analog beamforming matrices.

In one subembodiment, any two antenna ports in an antenna port group are Quasi-Colocated (QCL).

In one subembodiment, any two antenna ports in an antenna port group are spatial QCL.

In one embodiment, the multiple antenna port groups in the figure correspond to a Panel in this application.

In one embodiment, the first reference signal resource set corresponds to multiple antenna port groups.

In one embodiment, the second reference signal resource set corresponds to multiple antenna port groups.

In one embodiment, one reference signal resource in the first reference signal resource set corresponds to one antenna port group.

In one embodiment, one reference signal resource in the second reference signal resource set corresponds to one antenna port group.

### Embodiment 13

Embodiment 13 illustrates a structure block diagram of a first node, as shown in FIG. 13. In FIG. 13, a first node 1300 comprises a first receiver 1301 and a first transmitter 1302.

The first receiver 1301 receives a first information set, the first information set being used to indicate a first reference signal resource set:
the first transmitter 1302 transmits a second information set.

In Embodiment 13, the second information set includes a first power difference and a second power difference; the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set; the first target power value and the second target power value are for a same cell, and both the first target power value and the second target power value are for a PUSCH.

In one embodiment, the first information set is used to indicate a second reference signal resource set; the second information set includes a third power difference and a fourth power difference: the third power difference is equal to a difference obtained by subtracting a third target power value from a third power value, and the fourth power difference is equal to a difference obtained by subtracting a fourth target power value from a fourth power value: the third target power value and the fourth target power value are both associated to a second reference signal resource in the second reference signal resource set: the third target power value and the fourth target power value are for a same cell, and both the third target power value and the fourth target power value are for a PUSCH.

In one embodiment, the first power value and the second power value are both associated to the first reference signal resource set, while the third power value and the fourth power value are both associated to the second reference signal resource set: the first power value is different from the second power value, and the third power value is different from the fourth power value.

In one embodiment, the first receiver 1301 receives a first signaling; and the first transmitter 1302 transmits a first signal: the first signaling is used to determine the first reference signal resource, and the first reference signal resource is used to determine a spatial transmission (Tx) parameter for the first signal, a transmission power value of the first signal being equal to the first target power value.

In one embodiment, the first receiver 1301 has not detected any downlink control information used to indicate uplink scheduling in a first time window: the uplink scheduling includes a physical uplink shared channel, and a power control parameter associated with the first reference signal resource is pre-defined.

In one embodiment, the first receiver 1301 receives a first signaling, and the first transmitter 1302 transmits a first signal: the first signaling is used to determine the first reference signal resource and the second reference signal resource, and the first signal comprises a first sub-signal and a second sub-signal: the first reference signal resource is used to determine a spatial transmission (Tx) parameter for the first sub-signal, while the second reference signal resource is used to determine a spatial Tx parameter for the second sub-signal: a transmission power value of the first sub-signal is equal to the second target power value, and a transmission power value of the second sub-signal is equal to the fourth target power value.

In one embodiment, a power control parameter associated with the second reference signal resource is predefined.

In one embodiment, a first value and a second value are both associated to the first reference signal resource set, and a first coefficient and a second coefficient are both associated to the first reference signal resource set: the first value and the first coefficient are used to determine the first target power value, while the second value and the second coefficient are used to determine the second target power value: the first value and the second value are of a same type, and the first coefficient and the second coefficient are of a same type.

In one embodiment, the first receiver 1301 comprises at least the first four of the antenna 452, the receiver 454, the multi-antenna receiving processor 458, the receiving processor 456 and the controller/processor 459 in Embodiment 4.

In one embodiment, the first transmitter 1302 comprises at least the first four of the antenna 452, the transmitter 454, the multi-antenna transmitting processor 457, the transmitting processor 468 and the controller/processor 459 in Embodiment 4.

In one embodiment, the first information set is transmitted via an RRC signaling, the first parameter set and the second parameter set are both used for uplink power control corresponding to the same SRS resource, the second information set is a PHR, the first power difference and the second power difference are both PH: the first target power value and the second target power value are both associated to a first reference signal resource in the first reference signal resource set: the first target power value and the second target power value are for a same cell, and both the first target power value and the second target power value are for a PUSCH.

### Embodiment 14

Embodiment 14 illustrates a structure block diagram of a second node, as shown in FIG. 14. In FIG. 14, a second node 1400 comprises a second transmitter 1401 and a second receiver 1402.

The second transmitter 1401 transmits a first information set, the first information set being used to indicate a first reference signal resource set:
the second receiver 1402 receives a second information set.

In Embodiment 14, the second information set includes a first power difference and a second power difference: the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a PUSCH.

In one embodiment, the first information set is used to indicate a second reference signal resource set; the second information set includes a third power difference and a fourth power difference: the third power difference is equal to a difference obtained by subtracting a third target power value from a third power value, and the fourth power difference is equal to a difference obtained by subtracting a fourth target power value from a fourth power value: the third target power value and the fourth target power value are both associated to a second reference signal resource in the second reference signal resource set: the third target power value and the fourth target power value are for a same cell, and both the third target power value and the fourth target power value are for a PUSCH.

In one embodiment, the first power value and the second power value are both associated to the first reference signal resource set, while the third power value and the fourth power value are both associated to the second reference signal resource set: the first power value is different from the second power value, and the third power value is different from the fourth power value.

In one embodiment, the second transmitter 1401 transmits a first signaling; and the second receiver 1402 receives a first signal: the first signaling is used to determine the first reference signal resource, and the first reference signal resource is used to determine a spatial transmission (Tx) parameter for the first signal, a transmission power value of the first signal being equal to the first target power value.

In one embodiment, the second transmitter 1401 does not transmit any downlink control information used to indicate uplink scheduling of the first node in a first time window: the uplink scheduling includes a physical uplink shared channel, and a power control parameter associated with the first reference signal resource is pre-defined.

In one embodiment, the second transmitter 1401 transmits a first signaling, and the second receiver 1402 receives a first signal: the first signaling is used to determine the first reference signal resource and the second reference signal resource, and the first signal comprises a first sub-signal and a second sub-signal: the first reference signal resource is used to determine a spatial transmission (Tx) parameter for the first sub-signal, while the second reference signal resource is used to determine a spatial Tx parameter for the second sub-signal; a transmission power value of the first sub-signal is equal to the second target power value, and a transmission power value of the second sub-signal is equal to the fourth target power value.

In one embodiment, a power control parameter associated with the second reference signal resource is predefined.

In one embodiment, a first value and a second value are both associated to the first reference signal resource set, and a first coefficient and a second coefficient are both associated to the first reference signal resource set: the first value and the first coefficient are used to determine the first target power value, while the second value and the second coefficient are used to determine the second target power value: the first value and the second value are of a same type, and the first coefficient and the second coefficient are of a same type.

In one embodiment, the second transmitter 1401 comprises at least the first four of the antenna 420, the transmitter 418, the multi-antenna transmitting processor 471, the transmitting processor 414 and the controller/processor 475 in Embodiment 4.

In one embodiment, the second receiver 1402 comprises at least the first four of the antenna 420, the receiver 418, the multi-antenna receiving processor 472, the receiving processor 470 and the controller/processor 475 in Embodiment 4.

In one embodiment, the first information set is transmitted via an RRC signaling, the first parameter set and the second parameter set are both used for uplink power control corresponding to the same SRS resource, the second information set is a PHR, the first power difference and the second power difference are both PH: the first target power value and the second target power value are both associated to a first reference signal resource in the first reference signal resource set: the first target power value and the second target power value are for a same cell, and both the first target power value and the second target power value are for a PUSCH.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IoT terminals, vehicle-mounted communication equipment, vehicles, automobiles, RSU, aircrafts, airplanes, unmanned aerial vehicles, telecontrolled aircrafts, etc. The second node in the present application includes but is not limited to macro-cellular base stations, micro-cellular base stations, home base stations, relay base station, eNB, gNB, Transmitter Receiver Point (TRP), GNSS, relay satellite, satellite base station, airborne base station, RSU, unmanned ariel vehicle, test equipment like transceiving device simulating partial functions of base station or signaling tester, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information set, the first information set being used to indicate a first reference signal resource set; and
a first transmitter, transmitting a second information set;
wherein the second information set includes a first power difference and a second power difference: the first power difference is equal to a difference obtained by subtracting a first target power value from a first power value, and the second power difference is equal to a difference obtained by subtracting a second target power value from a second power value; the first target power value and the second target power value are both associated to a first reference signal resource in the first reference signal resource set: the first target power value and the second target power value are for a same cell, and both the first target power value and the second target power value are for a PUSCH.

2. The first node according to claim 1, characterized in that the first information set is used to indicate a second reference signal resource set: the second information set includes a third power difference and a fourth power difference: the third power difference is equal to a difference obtained by subtracting a third target power value from a third power value, and the fourth power difference is equal to a difference obtained by subtracting a fourth target power value from a fourth power value; the third target power value and the fourth target power value are both associated to a second reference signal resource in the second reference signal resource set; the third target power value and the fourth target power value are for a same cell, and both the third target power value and the fourth target power value are for a PUSCH.

3. The first node according to claim 2, characterized in that the first power value and the second power value are both associated to the first reference signal resource set, while the third power value and the fourth power value are both associated to the second reference signal resource set: the first power value is different from the second power value, and the third power value is different from the fourth power value.

4. The first node according to claim 1, characterized in comprising:
the first receiver, receiving a first signaling; and
the first transmitter, transmitting a first signal;
wherein the first signaling is used to determine the first reference signal resource, and the first reference signal resource is used to determine a spatial transmission (Tx) parameter for the first signal, a transmission power value of the first signal being equal to the first target power value.

5. The first node according to claim 1, characterized in comprising:
the first receiver, not having detected any downlink control information used to indicate uplink scheduling in a first time window;
wherein the uplink scheduling includes a physical uplink shared channel, and a power control parameter associated with the first reference signal resource is pre-defined.

6. The first node according to claim 2, characterized in comprising:
the first receiver, receiving a first signaling; and
the first transmitter, transmitting a first signal;
wherein the first signaling is used to determine the first reference signal resource and the second reference signal resource, and the first signal comprises a first sub-signal and a second sub-signal: the first reference signal resource is used to determine a spatial transmission (Tx) parameter for the first sub-signal, while the second reference signal resource is used to determine a spatial Tx parameter for the second sub-signal: a transmission power value of the first sub-signal is equal to the second target power value, and a transmission power value of the second sub-signal is equal to the fourth target power value.

7. The first node according to claim 2, characterized in that a power control parameter associated with the second reference signal resource is predefined.

8. The first node according to claim 3, characterized in that a first value and a second value are both associated to the first reference signal resource set, and a first coefficient and a second coefficient are both associated to the first reference signal resource set: the first value and the first coefficient are used to determine the first target power value, while the second value and the second coefficient are used to determine the second target power value: the first value and the second value are of a same type, and the first coefficient and the second coefficient are of a same type.

9. The first node according to claim 1, characterized in that a reference signal resource included in the first reference signal resource set is an SRS Resource, or a reference signal resource included in the first reference signal resource set is a CSI-RS Resource, or a reference signal resource included in the first reference signal resource set is an SSB.

10. The first node according to claim 1, characterized in that a reference signal resource included in the second reference signal resource set is an SRS Resource, or a reference signal resource included in the second reference signal resource set is a CSI-RS Resource, or a reference signal resource included in the second reference signal resource set is an SSB.

11. The first node according to claim 1, characterized in that the first power difference is a PH for the first reference signal resource, and the second power difference is a PH for the first reference signal resource.

12. The first node according to claim 1, characterized in that the first power difference is a corresponding PH for the first node when transmitting a radio signal only on a spatial transmission (Tx) parameter corresponding to one reference signal resource in the first reference signal resource set: the second power difference is a corresponding PH for the first node when transmitting radio signals simultaneously on a spatial transmission (Tx) parameter corresponding to one reference signal resource in the first reference signal resource set and a spatial transmission (Tx) parameter corresponding to one reference signal resource in the second reference signal resource set.

13. The first node according to claim 1, characterized in that the first target power value is a power value of a radio signal that the first node transmits only on a spatial transmission (Tx) parameter corresponding to one reference signal resource in the first reference signal resource set.

14. The first node according to claim 1, characterized in that the first node transmits two radio signals simultaneously on both a spatial transmission (Tx) parameter corresponding to a first reference signal resource in the first reference signal resource set and a spatial transmission (Tx) parameter corresponding to a second reference signal resource in the second reference signal resource set, and the second target power value is a transmission power value of a radio signal transmitted on the spatial Tx parameter corresponding to the first reference signal resource in the first reference signal resource set.

15. The first node according to claim 1, characterized in that the first target power value and the second target power value are both associated to the first reference signal resource in the first reference signal resource set, meaning at least one of:
the first reference signal resource in the first reference signal resource set being used to determine the first target power value and the second target power value; or
the first reference signal resource in the first reference signal resource set being associated to a given CSI-RS resource, and a channel quality for a radio signal received in the given CSI-RS resource being used to determine the first target power value and the second target power value; or
the first reference signal resource in the first reference signal resource set being associated to a given SSB, and a channel quality for a radio signal received in the given SSB being used to determine the first target power value and the second target power value.

16. A second node for wireless communications, comprising:
a second transmitter, transmitting a first information set, the first information set being used to indicate a first reference signal resource set; and
a second receiver, receiving a second information set;
wherein the second information set includes a first power difference and a second power difference; the first power difference is equal to a difference obtained by subtracting a first target power value from a first power value, and the second power difference is equal to a difference obtained by subtracting a second target power value from a second power value: the first target power value and the second target power value are both associated to a first reference signal resource in the first reference signal resource set: the first target power value and the second target power value are for a same cell, and both the first target power value and the second target power value are for a PUSCH.

17. The second node according to claim 16, characterized in that the first information set is used to indicate a second reference signal resource set: the second information set includes a third power difference and a fourth power difference: the third power difference is equal to a difference obtained by subtracting a third target power value from a third power value, and the fourth power difference is equal to a difference obtained by subtracting a fourth target power value from a fourth power value; the third target power value and the fourth target power value are both associated to a second reference signal resource in the second reference signal resource set; the third target power value and the fourth target power value are for a same cell, and both the third target power value and the fourth target power value are for a PUSCH.

18. The second node according to claim 17, characterized in that the first power value and the second power value are both associated to the first reference signal resource set, while the third power value and the fourth power value are both associated to the second reference signal resource set; the first power value is different from the second power value, and the third power value is different from the fourth power value.

19. The first node according to claim 1, characterized in comprising:
the first receiver, receiving a first signaling; and
the first transmitter, transmitting a first signal;
wherein the first signaling is used to determine the first reference signal resource, and the first reference signal resource is used to determine a spatial transmission (Tx) parameter for the first signal, a transmission power value of the first signal being equal to the first target power value;
or,
the first signaling is used to determine the first reference signal resource and the second reference signal resource, and the first signal comprises a first sub-signal and a second sub-signal; the first reference signal resource is used to determine a spatial transmission (Tx) parameter for the first sub-signal, while the second reference signal resource is used to determine a spatial Tx parameter for the second sub-signal; a transmission power value of the first sub-signal is equal to the second target power value, and a transmission power value of the second sub-signal is equal to the fourth target power value.

20. A method in a first node for wireless communications, comprising:
receiving a first information set, the first information set being used to indicate a first reference signal resource set; and
transmitting a second information set;
wherein the second information set includes a first power difference and a second power difference; the first power difference is equal to a difference obtained by subtracting a first target power value from a first power value, and the second power difference is equal to a difference obtained by subtracting a second target power value from a second power value; the first target power value and the second target power value are both associated to a first reference signal resource in the first reference signal resource set; the first target power value and the second target power value are for a same cell, and both the first target power value and the second target power value are for a PUSCH.
